(19) United States
(12) Patent Application Publication
(10) Pub. No.: US 2006/0273653 A1
(43) Pub. Date: Dec. 7, 2006

(54) Spoke light

(76) Inventors: Edward D. Lewis, Brownsburg, IN (US); Eric S. Roberts, Duluth, GA (US); Daniel B. Jarosinski, Indianapolis, IN (US)

Correspondence Address: BAHRET & ASSOCIATES, 320 NORTH MERIDIAN STREET, SUITE 510, INDIANAPOLIS, IN, 46204, US

(21) Appl. No.: 11/146,420

(22) Filed: Jun. 6, 2005

(51) Int. Cl. B60B 7/06

(52) U.S. Cl. 301/37.41

(57) ABSTRACT

A spoke-mounted, motion-activated light rod having a transparent column-shaped portion with irregularly spaced voids therein. An end cap has a receiving well for receiving an end of the transparent column and an attachment clip for attachment to a spoke during use. A body providing a component compartment has a rod receiving portion having a second receiving well for receiving an end of the transparent column and an attachment stem extending outwardly from the back having a spoke slot in axial alignment with the attachment clip of the end cap for receiving the spoke. The rod receiving portion has a light source compartment in axial alignment with the second receiving well for receiving an LED within the light source compartment that is cyclically activated by a motion-actuated switch. Illumination from the LED illuminates the transparent column and deflects off the voids therein.

### BACKGROUND OF THE INVENTION

This invention relates to decorative and/or safety lighting devices for bicycles and other vehicles, and, more particularly, to lighting devices for attachment to spokes.

Lighting devices have been incorporated into several different structures in the past to illuminate bicycle wheel spokes. For example, U.S. Pat. No. 4,176,390 to Galbert discloses a lighting device for connection to the wheel of a bicycle. A battery and a light bulb are spring biased such that the electrical connection between the battery and light bulb is normally open. The spring force of the spring separating the light bulb from the battery is overcome by centrifugal force generated by the rotation of the wheel during use, thus completing the electrical connection between the light bulb and the battery and thereby energizing the light bulb.

U.S. Pat. No. 5,624,175 issued to Gelormino et al. discloses a safety light of the type that connects between spokes of a bicycle. Movement of the safety light housing actuates a motion-sensitive switch that activates the control circuitry connecting the battery to a light source. The motion-sensitive switch disclosed by Gelormino et al. takes different forms. A first switch consists of a pivoting member that pivots between electrical contacts in response to movement of the housing. A second switch consists of a magnetic member moving within a coil to produce electricity that energizes the light source.

Although lighting devices, including motion-activated lighting devices, have been used in the past to illuminate bicycle wheel spokes, there still remains a need for improved decorative and/or safety lighting devices and effects for bicycle wheels and the like.

### SUMMARY OF THE INVENTION

One embodiment of the claimed invention is a spoke-mounted, motion-activated light rod having a transparent or translucent column-shaped portion with spaced light-scattering voids therein. An end cap having a receiving well for receiving an end of the transparent column and an attachment clip for attachment to a spoke is attached to an end of the column. A body providing a component compartment has a column-receiving portion having a second receiving well for receiving an end of the transparent column and an attachment stem extending outwardly from the back having a spoke slot in axial alignment with the attachment clip of the end cap for receiving the spoke. The column-receiving portion has a light source compartment in axial alignment with the second receiving well for receiving a light-emitting diode (LED) or other light-emitting element within the light source compartment that is activated by a motion-actuated switch within the body. Light from the light-emitting element illuminates the transparent column and is scattered by the voids therein.

In another embodiment of the invention, a spoke-mounted, motion-activated light comprises a transparent or translucent column-shaped portion having a generally flat end and spaced voids therein. A body having an attachment portion for attachment to an end of the column has a light-emitting element in axial alignment with the generally flat end of the column-shaped portion that is cyclically activated by a motion-actuated switch. Illumination from the light-emitting element illuminates the column-shaped portion and deflects off the voids therein. An attachment stem extending outwardly from the body has a spoke slot for receiving a spoke during use.

In a further embodiment of the invention, a spoke mounted light comprises a substantially solid transparent or translucent column-shaped portion having a light accentuating feature therein. A body having a side wall surrounding a back portion provides a component compartment that houses an LED in axial alignment with said column-shaped portion. The light accentuating feature increases the visual effect of the LED. Further, the spoke-mounted light has a column-receiving portion with a receiving well for receiving an end of the column and an attachment portion for attaching the column and body to a spoke during use.

In a still further embodiment of the invention, a spoke-mounted, motion-activated light rod having a transparent or translucent column-shaped portion with spaced voids therein is cyclically illuminated by an LED controlled by a motion-actuated switch. The illumination deflects off the voids and increases the visual effect of the LED.

In yet another embodiment of the invention, a spoke-mounted, motion-activated light rod comprises a transparent or translucent rod having bubbles therein. An end cap having a receiving well for receiving an end of the rod and an attachment clip for attachment to a spoke is attached to one end of the rod. A body having a side wall surrounding a back portion provides a component compartment that houses a motion-activated switch. A rod receiving portion has a second receiving well for receiving an end of the transparent rod and a light source compartment in axial alignment with said second receiving well. An attachment stem extending outwardly from the back portion of the body has a spoke slot in axial alignment with the attachment clip of the end cap for receiving the spoke during use. A light-emitting element within the light source compartment is cyclically activated by the motion-activated switch. Illumination from the light-emitting element illuminates the transparent rod and reflects off the bubbles therein.

In yet another embodiment of the invention, a spoke-mounted, motion-activated light rod has a transparent or translucent rod portion with irregularly spaced bubbles therein that is cyclically illuminated by an LED controlled by a motion-actuated switch. Illumination from the LED reflects off the bubbles and increases the visual effect of the LED.

A general object of the present invention is to provide improved decorative and/or safety lighting devices and effects for bicycle wheels and the like.

Another object of the invention is to provide a cyclically illuminated transparent light column adjacent the spokes of a wheel of a bicycle or other vehicle.

These and other objects and advantages of the present invention will become more apparent upon reading the following detailed description in conjunction with the accompanying drawings.

### BRIEF DESCRIPTION OF THE DRAWINGS

FIG. 1 is a perspective view of a first embodiment of a spoke-mounted light rod according to the present invention.

FIG. 2 is a perspective partial cutaway view of the spoke-mounted light rod of FIG. 1.

FIG. 3 is a cross-sectional view of a second embodiment of a spoke-mounted light rod according to the present invention.

FIG. 4 is a perspective view of a spoke-mounted light in use.

FIG. 5 is a perspective view of another embodiment of a spoke-mounted light rod according to the present invention.

### DETAILED DESCRIPTION OF PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

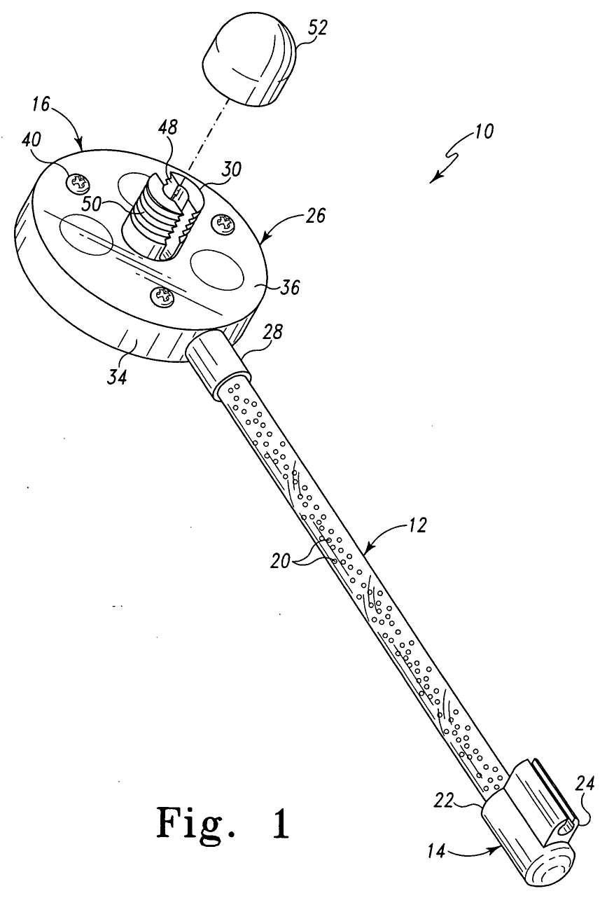

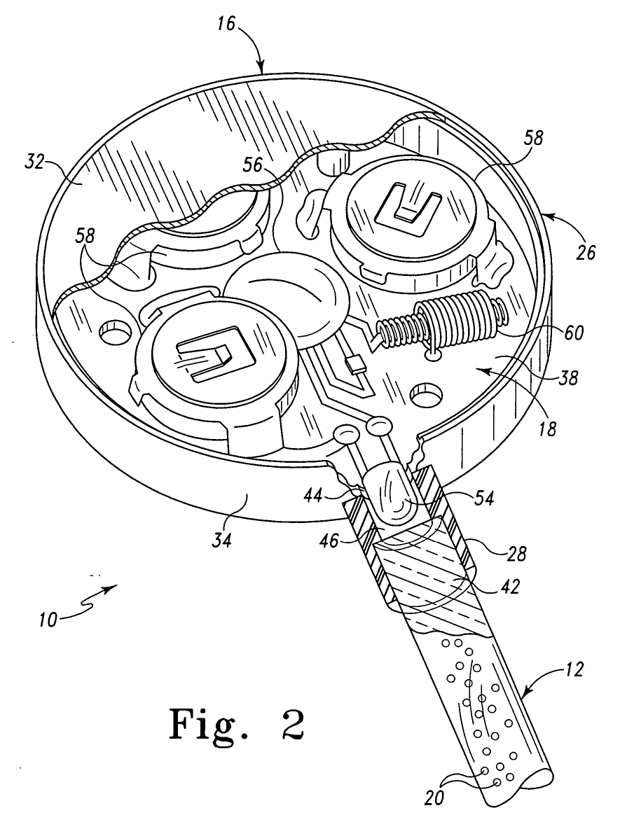

The spoke-mounted, motion-activated light rod 10 shown in FIGS. 1 and 2 generally comprises a transparent or translucent rod portion 12, a spoke mounting end cap 14, and a device housing 16 containing a light circuit 18 as shown in FIG. 2.

The transparent rod or column portion 12 as shown in FIGS. 1 and 2 generally has a cylindrical column shape and is preferably made of a durable transparent material such as acrylic with a plurality of irregularly spaced voids or bubbles 20 for light scattering, by which is meant reflection, refraction or diffraction of light. In a preferred embodiment, the rod portion 12 has a cross section of about 3/16 inch that is substantially sized and shaped to match the cross section of a typical bicycle wheel spoke and is about 3 Y2 inches in length, which is a substantial portion of the length of a typical spoke, particularly a spoke for a bicycle for young children, and even a spoke for a BMX bike, for example. A shorter or longer rod having a different cross sectional shape may be used in certain applications. For example, the rod portion could have a square cross section and have a length in excess of 6 inches. The rod may be extruded in longer lengths and cut to the desired length. The bubbles may be created by introducing air into the mold during the extrusion process.

The spoke mounting end cap 14 is preferably made of a durable transparent plastic. The end cap has a receiving well 22 for receiving an end of the transparent rod portion and an attachment clip 24 for attachment, preferably a snap fit, to a spoke of a bicycle wheel. The end cap could be structured in other ways while still achieving the objects of the invention. For example, an attachment portion having an attachment stud (not shown) may be used to attach to an end of the transparent rod that has a structurally complementing opening (not shown) for receiving the stud.

The device housing 16 is preferably made of a durable transparent plastic and comprises a disc-shaped main body 26, a rod receiving portion 28 extending from body 26, a spoke attachment stem 30 extending from the body, and a body cover 32 for covering the body.

The body 26 is preferably round in shape and has a side wall 34 that extends generally perpendicularly from the back 36 of the body forming an open component compartment 38. The body is preferably approximately 1½ inches in diameter and approximately ¼ inch thick. The body cover is preferably shaped similarly to the body and is sized to cover the component compartment. The body cover is preferably secured to the body by fasteners 40, but may be secured in other ways, such as, but not limited to, snap fitting.

The rod receiving portion 28 extends outwardly from the side wall of the body and has a second receiving well 42 for receiving an end of the transparent rod portion. The rod receiving portion could be structured in other ways while still achieving the objects of the claimed invention. For example, an attachment portion having an attachment stud (not shown) may be used to attach to an end of the transparent rod portion that has a structurally complementing opening (not shown) for receiving the stud. An aperture 44 through the side wall of the body provides a light source compartment 46 in axial alignment with the second receiving well 42.

The spoke attachment stem 30 extends outwardly from the back of the body and has a spoke slot 48 through the stem and threads 50 for receiving a threaded attachment stem cap 52.

The light circuit 18 shown in FIG. 2 is situated within the component compartment 38 of the body. The light circuit preferably comprises a light-emitting diode (LED) 54 controlled by an integrated circuit (IC) 56 that is energized by a battery power source 58 which in the disclosed embodiment consists of three AG10 batteries. The LED, IC and batteries are all mounted in a conventional manner on a printed circuit (pc) board as shown. The LED leads are soldered to the pc board in compartment 38 and the body of the LED is primarily situated within the light source compartment 46, extending through the aperture 44 and optically aligned with and coupled to receiving well 42 and rod 12 mounted therein.

The IC is preferably an LED driver configured to operate in one-shot mode and, in the embodiment of FIG. 2, is triggered by a normally open, motion-activated switch 60 which closes in response to a predetermined amount of force applied to the device housing. Switch 60 in this embodiment is a dual coil spring switch mounted on the pc board with its longitudinal axis perpendicular to the axis of rod 12, with one cantilever-mounted coil spring extending coaxially through a stationary coil spring as shown in the drawing. It will be appreciated that the switch is sensitive to centrifugal force generated by wheel motion, among other forces encountered during normal use of the bicycle. Another example of a suitable spring switch is disclosed in U.S. Pat. No. 6,419,384 to Lewis et al., which patent is expressly incorporated herein by reference.

A suitable IC for the embodiment of FIG. 2 is a type AP3761-03 IC, commercially available in die form from Advanced Microelectronic Products, Inc., Taiwan. With a normally open switch such as spring switch 60, the IC may be configured to operate in a retriggerable one-shot mode such that it is triggered when the switch first closes and is retriggered as long as the switch remains closed. The one-shot times out, and thus the LED turns off, a set period of time after the switch is opened. The IC may be configured to operate in one-shot mode generating a predetermined number of flashes or sequential ON intervals in a predetermined period of time in response to a trigger signal. So configured, the light circuit effectively creates moving bars of light on a revolving bicycle wheel.

In one contemplated embodiment, the light circuit has a bicolor or tricolor LED which is controlled by a suitable LED driver so as to sequentially produce bars of light in different colors, thereby producing a rainbow effect as described more fully in U.S. Pat. No. 6,206,537 to Hauck, which patent is hereby incorporated by reference. Likewise, a plurality of light rods 10 may be used to create the appearance of moving bars of light, providing amusement to the rider of the bicycle and others.

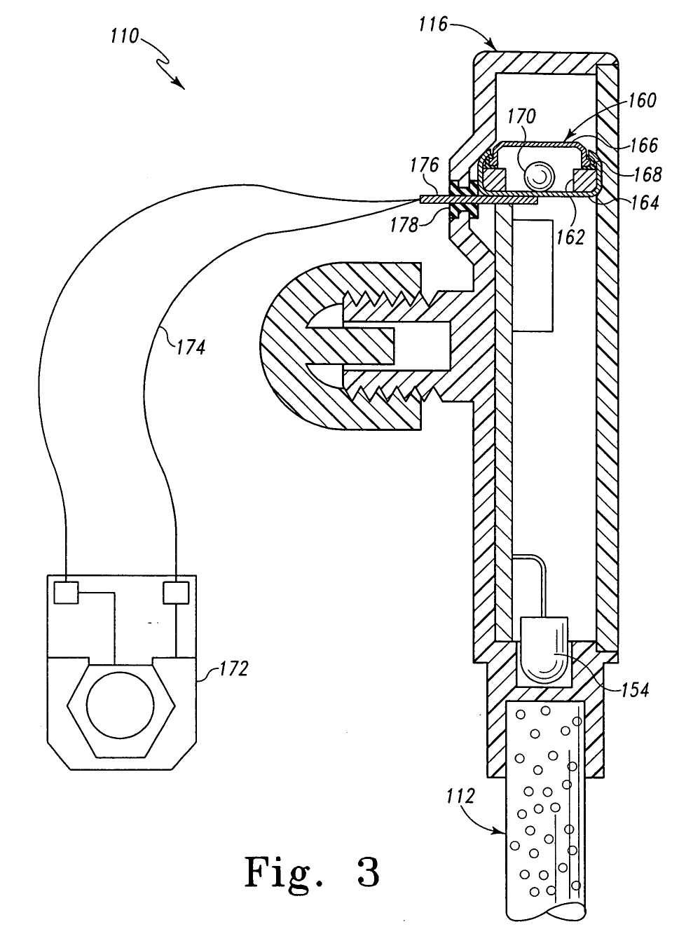

In the embodiment 110 of FIG. 3, which has a bubble rod 112 identical to rod 12 described above, with an LED 154 optically coupled to the bubble rod, an alternative motion-activated switch 160 has a BB or other movable conductive member contained within a modified button cell battery case, preferably an AG3 case, within a housing 116. The BB switch in the disclosed embodiment includes a conductive ring 162 inside and in electrical contact with the anode cup 164 which is insulated in a conventional manner from the cathode 166 by an annular insulator 168. The case is otherwise empty except for a BB 170 which is free to move within the case, both laterally and longitudinally. When the light rod is moved or oriented such that the BB simultaneously contacts the cathode and ring 162, the BB makes an electrical connection between the cathode and anode via the ring and thereby closes the switch and triggers an IC which controls the LED. The inside of the case may be gold plated for increased conductivity.

The IC for this embodiment is preferably configured to operate in true one-shot mode, i.e., as a non-retriggerable one-shot, whereby, once triggered, the one-shot cannot be triggered again during the timing interval and times out at the end of that interval. The IC is preferably edge-triggered but may be otherwise configured so as to require the switch to change state twice, e.g., to open and then close again, in order to trigger the IC after it has timed out. One suitable IC is available in die form, as part number wel62-7, from Winfar Electronics Co., Ltd, Shenzhen, China.

Also shown in FIG. 3 is a trial activation switch mechanism which may include a normally open membrane switch 172 having two contacts electrically connected by wires 174 to spaced contact points on a small pc board 176 or other material suitable for insertion in a hole provided for this purpose in the back of the body of the motion-activated light rod. Switch 172 is effectively connected in series with switch 160, whereby, when switch 172 is open, the light circuit is disabled, but, when switch 172 is closed, the light circuit is responsive to the motion-activated switch and may be tested by a prospective customer. Such a trial activation switch may be included in product packaging for the light rod, which may be sealed with installed batteries inside a blister pack, for example, except for the membrane switch, which is left exposed for prospective customers to use to test the product before purchase. The trial activation switch allows such testing while preventing battery drainage as might otherwise occur due to motion during shipment. A spring bias or other mechanism is provided to close the gap between the motion-activated switch and the associated switch contact on the light circuit pc board when the trial activation switch is removed. Also, an elastomeric seal 178 is provided to make the hole for pc board 176 a self-sealing hole.

The spoke-mounted, motion-activated light rod 10 as shown in FIGS. 1 and 2 is preferably assembled in the following manner. One end of the transparent rod portion 12 is inserted into the receiving well 22 of the spoke mounting end cap 14. The LED 54 is placed through the aperture 44 through the side wall 34 of the body 26 so that the LED is within the light source compartment 46 and the remainder of the light circuit is within the component compartment 38. Next, the body cover 32 is fastened to the body 26 utilizing a plurality of fasteners 40. Next, the other end of the transparent rod portion 12 is inserted into the receiving well 42 of the rod receiving portion 28, axially aligning the LED with an end of the transparent rod portion.

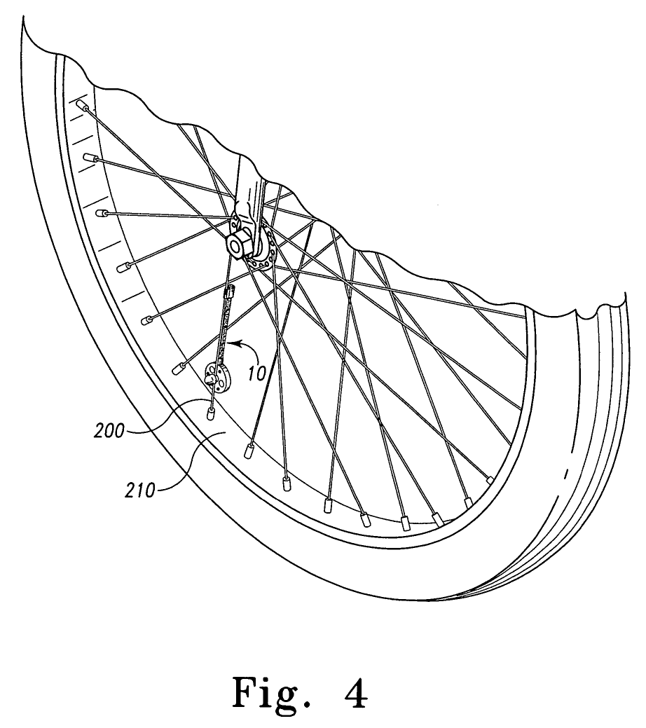

The light rod is used by mounting it to a spoke 200 of a wheel 210, such as a bicycle wheel as shown in FIG. 4, and then illuminating the light rod through rotation of the wheel by riding the bicycle. The light rod 10 is mounted by positioning it adjacent the spoke such that the spoke is within spoke slot 48 and then screwing the stem cap onto the attachment stem. The attachment clip 24 of the end cap 14 is pressed over the wheel spoke.

Centrifugal force created by rotation of the wheel acts upon the normally open motion-actuated switch that activates the control circuitry and energizes the LED. As the centrifugal force decreases, switch 60 opens and the IC thereafter times out. Light impinging on a given bubble 20 from the LED is refracted and/or reflected by the bubble, thereby increasing the visibility of the bubble as well as that of the entire length of the rod. The light rod construction thus makes it possible to efficiently and inexpensively light a substantial portion of a spoke length, and thereby produce a wide band of light covering a substantial portion or the area of a wheel when the bicycle is moving. For example, a rod portion 20 that is 3½ inches long as described above is approximately half the length of the spoke for a typical young child's bike, and more than a third of the typical spoke length for a BMX bike. If positioned close to the rim, such a rod produces a band of light that covers more than half the wheel area on a BMX bike and 75% or more of the wheel area on a typical bike ridden by young children. This not only makes the bicycle more noticeable from an aesthetic standpoint but also enhances the safety of the rider. This is especially the case with embodiments which have flashing light effects.

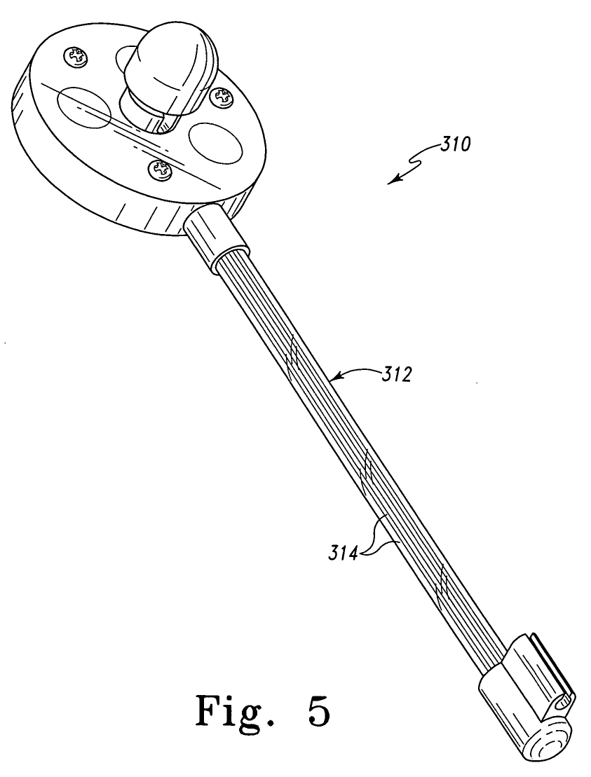

FIG. 5 illustrates an embodiment 310 of the present invention in which the transparent rod portion 312 has a plurality of laser-etched or laser-cut lines 314 along the length of the rod that accentuate the illumination produced by the LED(s) in the light circuit while in use. More specifically, such lines are formed in the rod portion parallel to the longitudinal axis thereof for the purpose of transmitting light from the LED(s) through the rod in distinguishable lines and radiating such light radially therefrom.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A spoke-mounted, motion-activated light rod, comprising:
a transparent or translucent column-shaped portion having spaced voids therein;
an end cap having a receiving well for receiving an end of said transparent column-shaped portion and an attachment clip for attachment to a spoke during use;
a body having a side wall surrounding a back portion providing a component compartment;
a column-receiving portion having a second receiving well for receiving an end of said column-shaped portion, said column-receiving portion having a light source compartment in axial alignment with said second receiving well;
an attachment stem extending outwardly from said back portion of said body and having a spoke slot in axial alignment with said attachment clip of said end cap for receiving the spoke during use;
a motion-activated switch within said body responsive to motion thereof; and
a light-emitting element within said light source compartment activated by said motion-activated switch, light from said light-emitting element illuminating said column-shaped portion and being scattered by said voids therein.

2. The rod of claim 1, wherein said light-emitting element is an LED.

3. The rod of claim 2, further comprising an aperture through said side wall of said body, said rod receiving portion extending outwardly from said side wall of said body in axial alignment with said aperture, said LED extending through said aperture into said light source compartment.

4. The rod of claim 3, further comprising a body cover for covering said component compartment.

5. The rod of claim 4, further comprising stem cap means for tightly securing said attachment stem to said spoke.

6. The rod of claim 5, wherein said end cap is made of transparent material providing visible illumination through said end cap from said LED.

7. A spoke-mounted, motion-activated light, comprising:
a transparent or translucent column-shaped portion having a generally flat end and voids therein;
a body having an attachment portion for attachment to an end of said transparent column-shaped portion;
an attachment stem extending outwardly from said body having a spoke slot for receiving a spoke during use; and
a light-emitting element in axial alignment with said generally flat end of said transparent or translucent column-shaped portion cyclically activated by a motion-actuated switch, light from said light-emitting element illuminating said column-shaped portion and being scattered by said voids therein.

8. The light of claim 7, wherein said light-emitting element is an LED.

9. The light of claim 8, further comprising an end cap having a second receiving well for receiving an end of said transparent column and an attachment clip in axial alignment with said spoke slot of said attachment stem for attachment to said spoke during use.

10. The light of claim 9, further comprising a stem cap threadedly engaging threads about said attachment stem, securing said attachment stem adjacent said spoke during use.

11. The rod of claim 10, wherein said end cap is made of transparent material providing visible light through said end cap from said LED.

12. A spoke-mounted light, comprising:
a substantially solid transparent or translucent column-shaped portion having a light-accentuating feature therein;
a body having a side wall surrounding a back portion providing a component compartment;
a column-receiving portion having a receiving well for receiving an end of said transparent or translucent column-shaped portion;
an attachment portion for attaching said transparent or translucent column-shaped portion and said body to a spoke during use; and
an LED in axial alignment with said transparent or translucent column-shaped portion illuminating said transparent or translucent column-shaped portion, said light-accentuating feature increasing visual effect of said LED.

13. The light of claim 12, further comprising a light source compartment providing space for said LED adjacent said column-shaped portion.

14. The light of claim 13, wherein said LED is activated by closure of a normally open switch.

15. The light of claim 14, further comprising an end cap having a second column-receiving portion for receiving an end of said transparent or translucent column-shaped portion and a second attachment portion in axial alignment with said attachment portion for attachment to said spoke during use.

16. The light of claim 15, wherein said end cap is made of transparent material providing visible light through said end cap from said LED.

17. A spoke-mounted, motion-activated light rod having a transparent or translucent column-shaped portion with voids therein that is cyclically lighted by an LED controlled by a motion-actuated switch, said light being scattered by said voids increasing visual effect of said LED.

18. The light rod of claim 17, further comprising an attachment portion for attaching said light rod to a spoke during use.

19. The light rod of claim 18, further comprising an end cap having a receiving well for receiving an end of said transparent or translucent column-shaped portion and a second attachment portion in axial alignment with said attachment portion for attachment to said spoke during use.

20. The light rod of claim 19, wherein said end cap is made of transparent material providing visible light through said end cap from said LED.

21. A spoke-mounted, motion-activated light rod, comprising:
a transparent or translucent rod having bubbles therein;
an end cap having a receiving well for receiving an end of said transparent or translucent rod and an attachment clip for attachment to a spoke during use;
a body having a side wall surrounding a back portion providing a component compartment;
a rod-receiving portion having a second receiving well for receiving an end of said transparent or translucent rod, said transparent or translucent rod-receiving portion having a light source compartment in axial alignment with said second receiving well;
an attachment stem extending outwardly from said back portion of said body having a spoke slot in axial alignment with said attachment clip of said end cap for receiving said spoke during use; and
a light-emitting element within said light source compartment activated by a motion-activated switch, light from said light-emitting element illuminating said transparent rod and being scattered by said bubbles therein.

22. The spoke-mounted motion-activated light rod of claim 21 wherein the motion-activated switch comprises a spring switch oriented perpendicular to the transparent or translucent rod.

23. A spoke-mounted, motion-activated light rod having a transparent or translucent rod portion with irregularly spaced bubbles therein that is illuminated by an LED controlled by a motion-actuated switch, said illumination being scattered by said bubbles increasing visual effect of said LED.

24. The spoke mounted light of claim 12, wherein the light-accentuating feature comprises a plurality of etched lines.

25. The spoke-mounted light of claim 12, wherein the light-accentuating feature comprises a plurality of bubbles within the transparent column.
